(19) United States
(12) Patent Application Publication
(10) Pub. No.: US 2024/0309220 A1
(43) Pub. Date: Sep. 19, 2024

(54) SPARKLE COATING FILM AND COVER

(71) Applicant: TOYODA GOSEI CO., LTD., Kiyosu-shi (JP)

(72) Inventors: Koichi MIYAKE, Kiyosu-shi (JP); Hiroaki ANDO, Kiyosu-shi (JP); Akira KAWAGUCHI, Kiyosu-shi (JP); Koji FUKAGAWA, Kiyosu-shi (JP)

(21) Appl. No.: 18/584,072

(22) Filed: Feb. 22, 2024

(30) Foreign Application Priority Data
Mar. 13, 2023 (JP) 2023-038728

(51) Int. Cl. C09D 5/33; C09D 5/28; C09D 7/40; C09D 7/61

(52) U.S. Cl. CPC C09D 5/004; C09D 5/28; C09D 7/61; C09D 7/70

(57) ABSTRACT

A sparkle coating film contains an infrared-transmissive base plastic and a filler added to the base plastic. The filler includes cold mirror flakes. Each cold mirror flake includes multiple first dielectric layers and multiple second dielectric layers having a refractive index lower than that of the first dielectric layers. The first dielectric layers and the second dielectric layers are laminated alternately. The cold mirror flakes each allow infrared light to pass through while reflecting visible light.

### BACKGROUND

### 1. Field

The present disclosure relates to a sparkle coating film and a cover.

### 2. Description of Related Art

Japanese Laid-Open Patent Publication No. 2010-30075 discloses a sparkle painted plastic product having electromagnetic wave transmissivity. The sparkle painted plastic product has a plastic base and a sparkle paint film provided on the plastic base. The sparkle paint film is formed by applying a paint containing flaky sparkle materials made of aluminum to the plastic base, and has millimeter wave transmissivity.

However, in the case of the sparkle painted plastic product described in the above publication, since the sparkle materials made of aluminum are blended in the coating film, infrared lights having wavelengths in a range of 800 nm to 3000 nm are reflected by the sparkle materials. This reduces the infrared transmissivity.

Accordingly, there is a demand for sparkle coating films and covers that possess infrared transmissivity while also exhibiting a sparkling appearance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a sparkle coating film includes an infrared-transmissive base plastic and a filler added to the base plastic. The filler includes cold mirror flakes. Each cold mirror flake includes multiple first dielectric layers and multiple second dielectric layers having a refractive index lower than that of the first dielectric layers. The first dielectric layers and the second dielectric layers are laminated alternately. Each cold mirror flake allows infrared light to pass through while reflecting visible light.

In another general aspect, a cover includes a transparent base, the above-described sparkle coating film and a visible-light blocking layer. The sparkle coating film is provided on the transparent base. The visible-light blocking layer is provided on a surface of the sparkle coating film on a side opposite to the transparent base. The visible-light blocking layer prevents transmission of visible light.

Other features and aspects will be apparent from the following detailed description, the drawings, and the claims.

### BRIEF DESCRIPTION OF THE DRAWINGS

FIG. 1 is a cross-sectional view of a cover according to an embodiment.

FIG. 2 is an enlarged cross-sectional view of the sparkle coating film shown in FIG. 1.

FIG. 3 is an enlarged cross-sectional view of a flake of the filler shown in FIG. 2.

FIG. 4 is a graph showing the relationship between the mass concentration of filler in sparkle coating films and the transmittance of infrared light having a wavelength of 900 nm.

FIG. 5 is a graph showing the relationship between the L*(25°) value of sparkle coating films and the transmittance of infrared light having a wavelength of 900 nm.

FIG. 6 is a graph showing the relationship between the L*(45°) value of sparkle coating films and the transmittance of infrared light having a wavelength of 900 nm.

FIG. 7 is a graph showing the relationship between the G value of sparkle coating films and the transmittances of infrared light having a wavelength of 900 nm.

FIG. 8 is a graph showing the relationship between the L*(25°) value and the L*(45°) value.

FIG. 9 is a graph showing the relationship between the Si(15°) value and the G value.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art.

Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

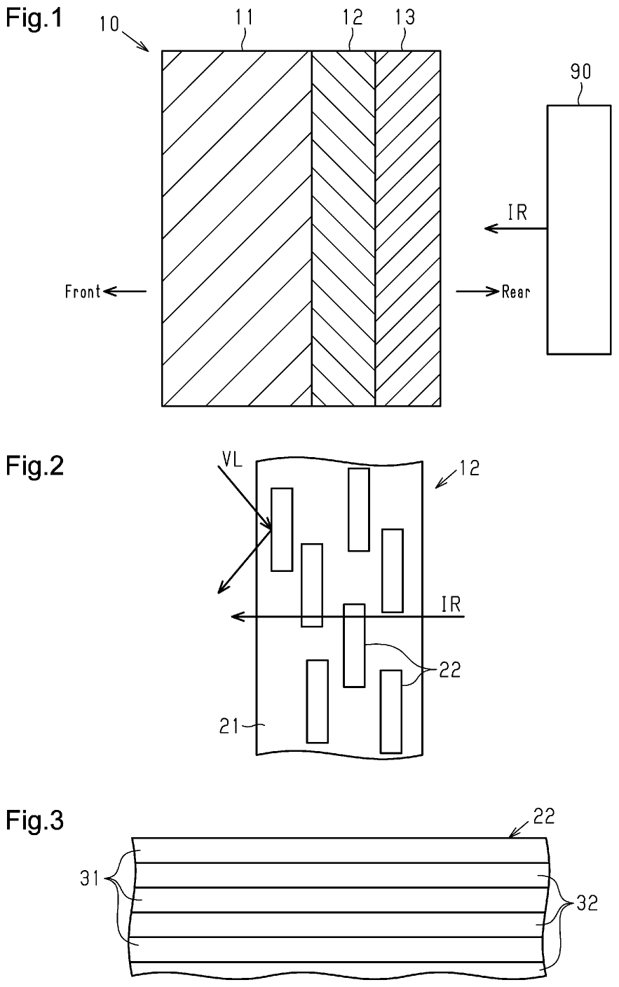

An infrared-transmissive sparkle coating film and a cover according to one embodiment will now be described with reference to FIGS. 1 to 9.

As shown in FIG. 1, a vehicle is provided with an infrared radar device 90. The infrared radar device 90 emits infrared light IR having wavelengths in a first wavelength band in a range of 880 nm to 930 nm or a second wavelength band in a range of 1540 nm to 1560 nm.

In the following description, the ‘front’ and ‘rear’ in the direction in which the infrared light from the infrared radar device 90 is emitted will simply be referred to as ‘front’ and ‘rear’, respectively.

The vehicle is provided with an infrared-transmissive cover 10 that covers the infrared radar device 90 from the front.

The cover 10 includes a transparent base 11, a sparkle coating film 12, and a visible-light blocking layer 13.

The transparent base 11 has infrared transmissivity. The transparent base 11 is made of a plastic such as polycarbonate, polymethyl methacrylate, cycloolefin polymer, and plastic glass. The transparent base 11 of the present embodiment is made of polycarbonate.

The sparkle coating film 12 is provided on the transparent base 11 and has infrared transmissivity.

The visible-light blocking layer 13 is provided on a surface of the sparkle coating film 12 on a side opposite to the transparent base 11, that is, on a rear surface of the sparkle coating film 12, to block transmission of visible light.

As shown in FIG. 2, the sparkle coating film 12 contains an infrared-transmissive base plastic 21 and a filler 22 added to the base plastic 21.

The sparkle coating film 12 is formed by applying a paint containing the base plastic 21 and the filler 22 to the rear surface of the transparent base 11. The paint may contain a curing agent as necessary.

### Base Plastic 21

The base plastic 21 as used herein contains at least one of the following as a main component: epoxy plastic, silicone plastic, urethane, urea-formaldehyde plastic, phenol plastic, polyethylene, polypropylene, polyethylene terephthalate, vinyl chloride, polystyrene, acrylonitrile-butadiene-styrene copolymer, acrylic plastic, polyamide, polyimide, polycarbonate, and melamine plastic. The “main component” refers to a component that affects the properties of the material, and the content of the “main component” is greater than or equal to 50% by mass.

The curing agent is used depending on the material of the base plastic 21. If the base plastic 21 used herein contains epoxy plastic as the main component, an acid anhydride curing agent or a phenol curing agent may be used. If the base plastic 21 used herein contains a material other than epoxy plastic as the main component, a curing agent may be omitted.

Depending on the purpose and the intended use, a curing agent other than an acid anhydride curing agent or a phenol curing agent may be used. Examples of such curing agents include an amine-based curing agent, an agent obtained by partially esterificating an acid anhydride curing agent with alcohol, and a curing agent of carboxylic acid such as hexahydrophthalic acid, tetrahydrophthalic acid, and methyl-hexahydrophthalic acid. One of the listed curing agents may be used alone. Alternatively, two or more of the curing agents may be used in combination. Further, any of the curing agents may be used with an acid anhydride curing agent and a phenol curing agent.

In a case in which a curing agent is used, a curing accelerator may be used together with the curing agent.

### Filler 22

As shown in FIG. 3, the filler 22 includes cold mirror flakes that reflect visible light (VL) while allowing infrared light (IR) to pass through. The cold mirror flakes each include multiple first dielectric layers 31 and multiple second dielectric layers 32, which have a refractive index lower than that of the first dielectric layers 31. The first dielectric layers 31 and the second dielectric layers 32 are laminated alternately.

The first dielectric layers 31 of the present embodiment are made of titanium dioxide (TiO₂). The second dielectric layers 32 of the present embodiment are made of silicon dioxide (SiO₂).

### Indicator for Achieving Metallic or Silver-Toned Sparkling Appearance.

The relationship among the L*(25°) value, the L*(45°) value, the Si(15°) value, and the G value required for the sparkle coating film 12 to achieve a metallic or silver-toned sparkling appearance will be described.

The L*(25°) value is an L* value that is an indicator of lightness when the incident angle is 450 and the receiving angle is 25°. The whiteness of the sparkle coating film 12 increases as the L*(25°) value increases. Also, the blackness of the sparkle coating film 12 increases as the L*(25°) decreases.

The L*(45°) value is an L* value that is an indicator of lightness when the incident angle is 45° and the receiving angle is 45°. The whiteness of the sparkle coating film 12 increases as the L*(45°) value increases. Also, the blackness of the sparkle coating film 12 increases as the L*(45°) decreases.

The Si(15°) value is an Si value that is an indicator of sparkling impression when the incident angle is 15° and the receiving angle is 0°. The sparking impression, i.e., the glittering impression, of the sparkle coating film 12 increases as the Si(15°) value increases. Also, the sparkling impression of the sparkle coating film 12 decreases as the Si(15°) value decreases.

The G value is an indicator of graininess. The graininess of the sparkle coating film 12 increases as the G value increases. Also, the graininess of the sparkle coating film 12 decreases as the G value decreases. In other words, the fineness increases as the G value decreases.

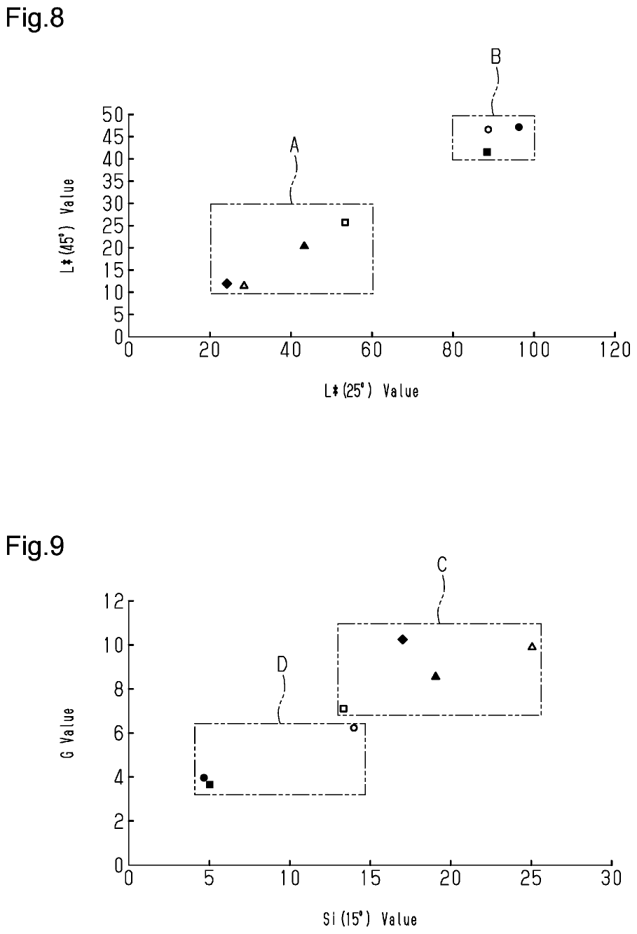

FIG. 8 shows the relationship between the L*(25°) value and the L*(45°) value measured using multiple types of existing sparkle coating films having metallic or silver-toned sparkling appearances.

The sparkle coating films included in region A shown in FIG. 8 have a metallic sparkling appearance. That is, when the L*(25°) value of a sparkle coating film is in a range of 20 to 60, and the L*(45°) value of the sparkle coating film is in a range of 10 to 30, the sparkle coating film has a metallic sparkling appearance.

The sparkle coating films included in region B shown in FIG. 8 have a silver-toned sparkling appearance. That is, when the L*(25°) value of a sparkle coating film is in a range of 80 to 100, and the L*(45°) value of the sparkle coating film is in a range of 40 to 50, the sparkle coating film has a silver-toned sparkling appearance.

FIG. 9 shows the relationship between the Si(15°) value and the G value measured using multiple types of existing sparkle coating films having metallic or silver-toned sparkling appearances.

The sparkle coating films included in region C shown in FIG. 9 have a metallic sparkling appearance. That is, when the Si(15°) value of a sparkle coating film is in a range of 15 to 25, and the G value of the sparkle coating film is in a range of 7 to 11, the sparkle coating film has a metallic sparkling appearance.

The sparkle coating films included in region D shown in FIG. 9 have a silver-toned sparkling appearance. That is, when the Si(15°) value of a sparkle coating film is in a range of 5 to 14, and the G value of the sparkle coating film is in a range of 3 to 6, the sparkle coating film has a silver-toned sparkling appearance.

From the above, in order for the sparkle coating film 12 to have a metallic sparkling appearance, the sparkle coating film 12 preferably has the following characteristics. It is preferable that the L*(25°) value is in the range of 20 to 60, the L*(45°) value is in the range of 10 to 30, the Si(15°) value is in the range of 15 to 25, and the G value is in the range of 7 to 11.

Further, in order for the sparkle coating film 12 to have a silver-toned sparkling appearance, the sparkle coating film 12 preferably has the following characteristics. It is preferable that the L*(25°) value is in the range of 80 to 100, the L*(45°) value is in the range of 40 to 50, the Si(15°) value is in the range of 4 to 14, and the G value is in the range of 3 to 6.

In order for the sparkle coating film 12 to have a metallic or silver-toned sparkling appearance, the sparkle coating film 12 preferably has the following characteristics. It is preferable that the L*(25°) value is in the range of 20 to 100, the L*(45°) value is in the range of 10 to 50, the Si(15°) value is in the range of 5 to 25, and the G value is in the range of 3 to 11.

### EXAMPLES AND COMPARATIVE EXAMPLES

Next, examples and comparative examples will be described.

Example 1 is a sparkle coating film 12 according to the present embodiment including a filler 22 including flakes, and each flake has a laminate structure of twenty layers of alternately laminated first dielectric layers 31 and second dielectric layers 32.

Example 2 is a sparkle coating film 12 according to the present embodiment including a filler 22 including flakes, and each flake has a laminate structure of twenty-five layers of alternately laminated first dielectric layers 31 and second dielectric layers 32.

Comparative Example 1 is a sparkle coating film including a base plastic 21 according to the present embodiment and a filler that includes aluminum flakes added to the base plastic 21.

Comparative Example 2 is a sparkle coating film including a base plastic 21 according to the present embodiment and a filler including evaporated aluminum added to the base plastic 21.

Comparative Example 3 is a sparkle coating film including a base plastic 21 according to the present embodiment and a filler that includes glass flakes added to the base plastic 21.

Comparative Example 4 is a sparkle coating film including a base plastic 21 according to the present embodiment and a filler that includes mica added to the base plastic 21.

The sparkle coating film 12 used for the infrared-transmissive cover 10, which covers the infrared radar device 90 from the front, preferably has a transmittance of 60% or more for infrared light with a wavelength of 900 nm.

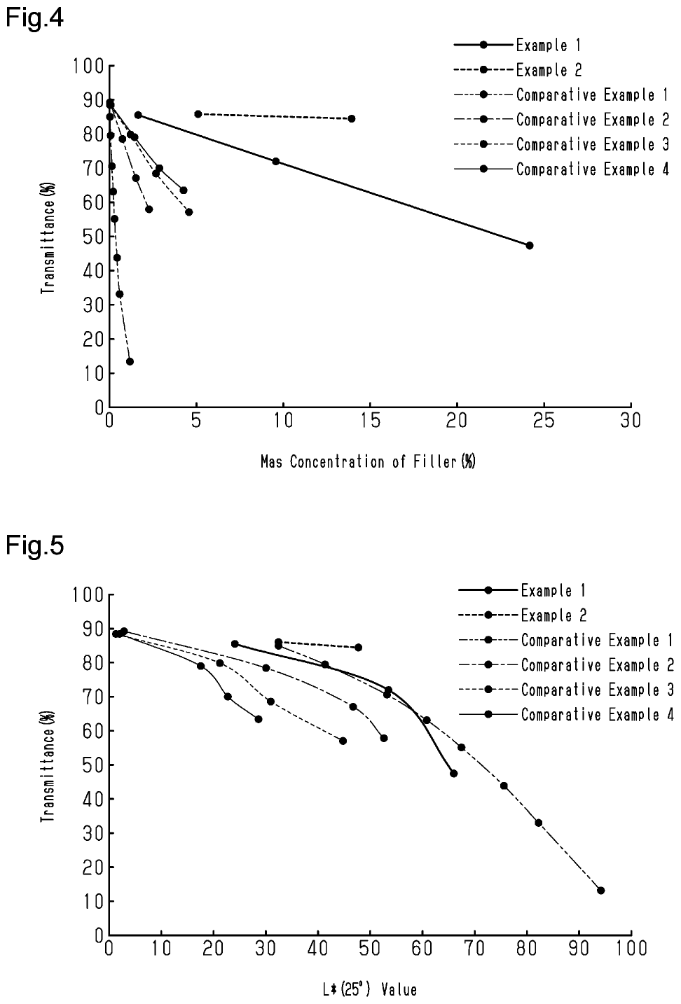

FIG. 4 shows the relationship between the mass concentration (%) of the filler of sparkle coating films and the transmittance (%) of infrared light having a wavelength of 900 nm.

As shown in FIG. 4, in Example 1, when the mass concentration of the filler 22 is 2%, the transmittance is 85%. When the mass concentration of the filler 22 is 9%, the transmittance is 72%. When the mass concentration of the filler 22 is 24%, the transmittance is 48%.

In Example 2, when the mass concentration of the filler 22 is 5%, the transmittance is 85%. When the mass concentration of the filler 22 is 15%, the transmittance is 84%.

In contrast, in the case in which the mass concentration of the filler is 0% in Comparative Examples 1 to 4, the transmittance is approximately 90%, but the transmittance is significantly reduced by the addition of the filler. Even in the case of Comparative Example 4, which has the highest transmittance among Comparative Examples 1 to 4, the transmittance is 63% when the mass concentration of the filler is 4%.

FIG. 5 shows the relationship between the L*(25°) value of sparkle coating films and the transmittance (%) of infrared light having a wavelength of 900 nm.

As shown in FIG. 5, in Examples 1 and 2, the L*(25°) value is in a range of 22 to 60 when the transmittance is 60% or higher.

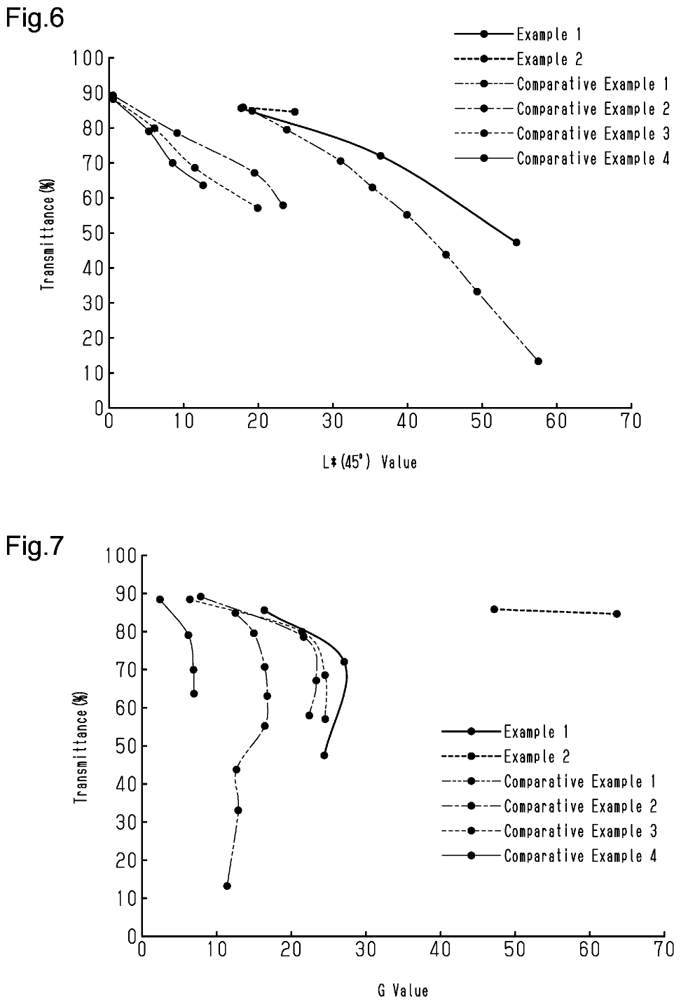

FIG. 6 shows the relationship between the L*(45°) value of sparkle coating films and the transmittance (%) of infrared light having a wavelength of 900 nm.

As shown in FIG. 6, in Examples 1 and 2, the L*(45°) value is in a range of 17 to 45 when the transmittance of 60% or higher.

FIG. 7 shows the relationship between the G value of sparkle coating films and the transmittance (%) of infrared light having a wavelength of 900 nm.

As shown in FIG. 7, in Example 1, the G value is in a range of 17 to 27 when the transmittance of 60% or higher. In Example 2, the G value is in a range of 46 to 62 when the transmittance of 60% or higher.

The L*(25°) value, the L*(45°) value, the Si(15°) value, and the G value were measured using a multi-angle spectrophotometer BYK-maci (manufactured by BYK-Gardner).

The present embodiment has the following advantages.

(1) The sparkle coating film 12 contains the infrared-transmissive base plastic 21 and the filler 22 added to the base plastic 21. The filler 22 includes cold mirror flakes. The cold mirror flakes each include the first dielectric layers 31 and the second dielectric layers 32, which have a refractive index lower than that of the first dielectric layers 31. The first dielectric layers 31 and the second dielectric layers 32 are laminated alternately. The cold mirror flakes each allow infrared light to pass through while reflecting visible light.

With this configuration, since the filler 22 includes cold mirror flakes that reflect visible light, the filler 22 reflects visible light so that the sparkle coating film 12 has a sparkling appearance. Further, the filler 22 includes optical flakes that allow infrared light to pass through. Therefore, even when the proportion of the filler 22 is increased to enhance the aesthetic appeal of the sparkle coating film 12, the transmittance of infrared light is not significantly reduced.

In addition, with the above-described configuration, by appropriately setting the number of laminated layers of the first dielectric layers 31 and the second dielectric layers 32, which form the respective cold mirror flakes, it is possible to readily adjust the reflectance of visible light by the filler 22, that is, the sparkling appearance and the transmittance of infrared light.

Therefore, the filler 22 has a sparkling appearance while having infrared transmissivity.

(2) The G value of the sparkle coating film 12 is in the range of 3 to 11. The L*(25°) value of the sparkle coating film 12 is in the range of 20 to 100.

With this configuration, the sparkle coating film 12 has a silver-toned or metallic sparkling appearance while having infrared transmissivity.

(3) The G value of the sparkle coating film 12 is in the range of 3 to 6. The L*(25°) value of the sparkle coating film 12 is in the range of 80 to 100.

With this configuration, the sparkle coating film 12 has a silver-toned sparkling appearance while having infrared transmissivity.

(4) The G value of the sparkle coating film 12 is in the range of 7 to 12. The L*(25°) value of the sparkle coating film 12 is in the range of 20 to 60.

With this configuration, the sparkle coating film 12 has a metallic sparkling appearance while having infrared transmissivity.

(5) The L*(45°) value of the sparkle coating film 12 is in the range of 10 to 50.

With this configuration, the sparkle coating film 12 further reliably has a silver-toned or metallic sparkling appearance while having infrared transmissivity.

(6) The transmittance of infrared light having a wavelength of 900 nm is greater than or equal to 60%.

With this configuration, the sparkle coating film 12 is used in the cover 10, which covers the infrared radar device 90 from the front.

(7) The cover 10 includes the transparent base 11, the sparkle coating film 12, which is provided on the transparent base 11, and the visible-light blocking layer 13, which is provided on the surface of the sparkle coating film 12 on the side opposite to the transparent base 11 and blocks transmission of visible light.

This configuration achieves operational advantages similar to the above-described operational advantages (1) to (6).

### Modifications

The above-described embodiment may be modified as follows. The above-described embodiment and the following modifications can be combined as long as the combined modifications remain technically consistent with each other.

The first dielectric layers 31 and the second dielectric layers 32, which form a cold mirror flake, do not necessarily need to be made of titanium dioxide and silicon dioxide. Alternatively, the first dielectric layers 31 and the second dielectric layers 32 may be made of, for example, tantalum pentoxide (Ta₂O₅) and silicon dioxide, or zinc sulfide (ZnS) and magnesium fluoride (MgF₂).

The sparkle coating film can also be used as a component that has both infrared transmissivity and millimeter wave transmissivity. In addition, the cover may include a sparkle coating film that has both infrared transmissivity and millimeter wave transmissivity.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A sparkle coating film, comprising an infrared-transmissive base plastic and a filler added to the base plastic, wherein
the filler includes cold mirror flakes,
each cold mirror flake includes:
multiple first dielectric layers; and
multiple second dielectric layers having a refractive index lower than that of the first dielectric layers,
the first dielectric layers and the second dielectric layers are laminated alternately, and
each cold mirror flake allows infrared light to pass through while reflecting visible light.

2. The sparkle coating film according to claim 1, wherein
a G value that is an indicator of graininess is in a range of 3 to 11,
an L* value that is an indicator of lightness when an incident angle is 45° and a receiving angle is 250 is referred to as an L*(25°) value, and
the L*(25°) value is in a range of 20 to 100.

3. The sparkle coating film according to claim 2, wherein
the G value is in a range of 3 to 6, and
the L*(25°) value is in a range of 80 to 100.

4. The sparkle coating film according to claim 2, wherein
the G value is in a range of 7 to 12, and
the L*(25°) value is in a range of 20 to 60.

5. The sparkle coating film according to claim 2, wherein
an L* value that is an indicator of lightness when the incident angle is 450 and the receiving angle is 450 is referred to as an L*(45°) value, and
the L*(45°) value is in a range of 10 to 50.

6. The sparkle coating film according to claim 1, wherein a transmittance of infrared light with a wavelength of 900 nm is greater than or equal to 60%.

7. A cover, comprising:
a transparent base;
the sparkle coating film according to claim 1, the sparkle coating film being provided on the transparent base; and
a visible-light blocking layer provided on a surface of the sparkle coating film on a side opposite to the transparent base, the visible-light blocking layer preventing transmission of visible light.
